(19) United States
(12) Patent Application Publication
(10) Pub. No.: US 2025/0372668 A1
(43) Pub. Date: Dec. 4, 2025

(54) FUEL CELL SYSTEM FOR GENERATING ELECTRICAL ENERGY

(71) Applicant: AVL List GmbH, Graz (AT)

(72) Inventors: Raphael NEUBAUER, Graz (AT); Markus GOLL, Graz (AT); Bhargav PANDYA, Graz (AT)

(73) Assignee: AVL List GmbH, Graz (AT)

(21) Appl. No.: 18/875,206

(22) PCT Filed: Aug. 8, 2023
(86) PCT No.: PCT/AT2023/060263

§ 371 Date: Dec. 16, 2024

(30) Foreign Application Priority Data
Aug. 9, 2022 (AT) A 50612/2022

(51) Int. Cl. H01M 8/04007; H01M 8/04082; H01M 8/04119; H01M 8/04701

(52) U.S. Cl. CPC H01M 8/04007; H01M 8/04164; H01M 8/04201; H01M 8/04708; H01M 8/04716

(57) ABSTRACT

The present invention relates to a fuel cell system (100) for generating electrical energy, comprising a fuel cell stack (110) with an anode section (120) and a cathode section (130), the anode section (120) comprising an anode feed section (122) for supplying anode feed gas (AZG) and an anode discharge section (124) for discharging anode exhaust gas (AAG), wherein the anode discharge section (124) transitions into an anode recirculation section (140) for recirculating the anode exhaust gas (AAG) as anode recirculation gas (ARG) to the anode feed section (122), the cathode section (130) comprising a cathode feed section (132) for supplying cathode feed gas (KZG) and a cathode discharge section (134) for discharging cathode exhaust gas (KAG), wherein an active cooling device (180) is arranged in the anode recirculation section (140) for cooling the anode recirculation gas (ARG), wherein a water outlet (128) is arranged downstream of the active cooling device (180) to discharge the condensation water (KW) condensed in the active cooling device (180), wherein a mixing section (123) is arranged downstream of the water outlet (128) for mixing the anode recirculation gas (ARG) with fuel gas (BRG) and for supplying this, as anode feed gas (AZG), into the anode feed section (122).

The present invention relates to a fuel cell system for generating electrical energy and a method for recirculating anode exhaust gas in such a fuel cell system.

It is known that fuel cell systems are used for the generation of electrical energy. For this purpose, these fuel cell systems are usually equipped with fuel cell stacks in which numerous individual fuel cells, each with an anode section and a cathode section, are stacked. To generate electrical energy, fuel gas and usually ambient air are fed into the fuel cell stack so that a chemical reaction of these gases can take place there, generating electrical energy.

In known fuel cell systems, either hydrogen or natural gas is usually used as fuel gas. In addition, it is known for part of the fuel gas which is not reacted during the reaction in the fuel cell stack to be fed back into the fuel cell stack as recirculation gas for recirculation in order to increase the efficiency in the use of the fuel gas.

A disadvantage of the known solutions is that recirculation can reduce efficiency in operation, in particular when hydrogen is used as fuel gas. If hydrogen is fed into a fuel cell stack, this hydrogen is converted in the anode section to a mixture of water and a remaining residue of hydrogen in the anode exhaust gas. During the recirculation of this gas mixture, it can happen that the water contained therein significantly decreases the Nernst voltage. The decrease in the Nernst voltage for the fuel cell stack leads to a reduction in efficiency, which usually offsets the increase in efficiency due to recirculation. In other words, when operating a fuel cell system with hydrogen, recirculation does not lead to the desired increase in efficiency, or only does so to a reduced extent.

Although it is already known in principle that, during recirculation, cooling of the anode exhaust gas can be used to condense part of the water contained therein and to separate this condensation water, these construction designs are however very complex and costly. In particular, they are based on the fact that an external cooling circuit must be used which is able to pass coolant to the recirculation line with an external heat sink in order to cause condensation of the vaporous water in the anode exhaust gas. The addition of an additional cooling circuit and the corresponding peripherals leads to an undesirable increase in the complexity and costs of a fuel cell system.

It is the object of the present invention to remedy, at least in part, the disadvantages described above. In particular, it is the object of the present invention to discharge condensation water in a fuel cell system in a cost-effective and simple manner, even when operated with hydrogen.

The above object is achieved by a fuel cell system with the features of claim 1 as well as a method with the features of claim 15. Further features and details of the invention are disclosed in the dependent claims, the description and the drawings.

Naturally, features and details described in connection with the fuel cell system according to the invention also apply in connection with the method of the invention and vice versa, so that with regard to disclosure mutual reference is or can always be made to the individual aspects of the invention.

According to the invention, a fuel cell system is proposed for generating electrical energy. Such a fuel cell system has a fuel cell stack with an anode section and a cathode section. The anode section is equipped with an anode feed section for supplying anode feed gas and an anode discharge section for discharging anode exhaust gas. In addition, the anode feed section transitions into an anode recirculation section to recirculate the anode exhaust gas as anode recirculation gas to the anode feed section. The cathode section also has a cathode feed section for supplying cathode feed gas and a cathode discharge section for discharging cathode exhaust gas. A fuel cell system according to the invention is characterised in that an active cooling device is arranged in the anode recirculation section for cooling the anode recirculation gas. Downstream of the active cooling device, a water outlet is arranged downstream of the condenser device to discharge the condensation water condensed in the active cooling device. A mixing section is arranged further downstream of the water outlet for mixing the anode recirculation gas with the fuel gas and for supplying this, as anode feed gas, into the anode feed section.

The core idea of the invention is based on ensuring a recirculation of anode exhaust gas as anode recirculation gas. The recirculation of the anode recirculation gas takes place in a dried manner, namely by passing it through an active cooling device. In this active cooling device, the temperature of the anode recirculation gas is brought below the boiling temperature of water, i.e. below about 100° C., depending on the pressure situation and depending on the partial pressure, which depends on the composition of the gas. This leads to the water vapour contained in the anode recirculation gas condensing out in the form of liquid condensation water.

A separator is provided downstream of the active cooling device as a water outlet in which the condensed components and thus the condensation water are separated from the gaseous components of the anode recirculation gas. This allows the liquid condensation water to be removed from the system and for example discharged into the environment. The remaining anode recirculation gas can also be described as dried anode recirculation gas and can accordingly be fed into a mixing section in this dried situation. In this mixing section, which can for example be designed as an ejector device, a mixing chamber or in a similar way, the anode recirculation gas is mixed with a fuel gas supplied from a fuel gas source. Depending on how much anode recirculation gas is available, the necessary residual amount of fuel gas can be added accordingly. The mixed gas consisting of fuel gas and anode recirculation gas is then fed back into the anode section of the fuel cell stack as anode feed gas.

The core idea of the invention is based, among other things, on the fact that no external cooling source nor any separate external refrigeration circuit is required for the condensation of the condensation water in the anode recirculation gas or in the anode exhaust gas. Instead, the active cooling device is provided according to the invention. According to the invention, the condensation process in this active cooling device takes place without the influence of external cooling sources, in particular without an external cooling circuit of the fuel cell system.

It should also be noted that, in a complex fuel cell system, cooling circuits may of course be provided at other positions in order to be able to carry out desired temperature control processes. In particular, very high temperatures are to be expected in fuel cell systems that are designed as SOFC systems, so that parts of the fuel cell stack can for example be designed with an external cooling device. According to the invention, however, any such existing external cooling source is also not used for the condensing function of the anode recirculation gas and the anode exhaust gas.

According to the invention, the integration of the condensation function by means of the active cooling device achieves the desired condensation of condensation water in the anode recirculation gas. In this way, dried anode recirculation gas is mixed with the fuel gas and, accordingly, the desired increase in efficiency is achieved through recirculation without having to accept a reduced Nernst voltage, as in the case of undried anode recirculation gas. Compared to the known solutions, this drying step and the associated increase in efficiency in the operation of the fuel cell system is achieved without additional complex components.

As a result, in addition to the increase in efficiency, in particular a smaller ejector can actually be used, since correspondingly lower volume flows have to be added to the fuel gas due to the separation of the unwanted condensation water.

In the solution of the fuel cell system according to the invention, a separate external cooling circuit is no longer used, its place being taken by the active cooling device. In the context of the present invention, an active cooling device is to be understood as an active generation of cold, and thus an active generation of a heat sink. In particular, thermally activated and/or electrically activated heat sinks are conceivable. A thermally activated heat sink can for example be an absorption heat pump. The use of electric compressors and, accordingly, cold generated via a refrigerant by a change in pressure can also be used here as an electrically activated cooling device.

Of course, other active cooling devices are also conceivable in principle which generate the desired heat sink in situ without having to resort to a separate external cooling circuit.

Significant advantages of a fuel cell system according to the invention therefore arise in particular from the fact that, through the active cooling, a maximum recirculation rate of up to 100% of the anode exhaust gas as anode recirculation gas is possible. In other words, it is possible to design the anode section as a so-called dead end, since 100%, i.e. all of the anode exhaust gas discharged there is fed back into the anode feed gas as anode recirculation gas. This makes it possible to further reduce the complexity of the fuel cell system as a whole and also, in particular, to avoid the expense of a post-treatment of the exhaust gas substantially completely. With known solutions, the collected exhaust gas from the fuel cell system usually has to be post-treated, for example with the help of an oxidation catalyst, in order to oxidise residual and remaining fuel gas in the anode exhaust gas and thus burn it in a targeted manner before the mixed exhaust gas is released into the environment. Due to the fact that, in the design of a fuel cell system according to the invention, a recycling rate and thus a recirculation rate of 100% of the anode exhaust gas is now possible, no discharge of this anode exhaust gas into the environment is provided at all. A post-treatment of the anode exhaust gas, which is no longer released into the environment, is therefore also no longer necessary. Finally, it should be pointed out that the mixing section, for example in the form of an injector device, can also function with less pressure on the primary side and can therefore be designed smaller and more cost-effectively.

It can bring advantages if, in a fuel cell system according to the invention, the active cooling device comprises a thermally activated cooling device, in particular comprising an absorption heat pump. The active cooling device is in heat-transferring contact with the cathode discharge section and is equipped for thermal activation by means of the heat contained in the cathode exhaust gas. As already explained in the introduction, a thermally activated cooling device is a possible embodiment of an active cooling device according to the invention. In this embodiment, heat which is provided by the fuel cell system itself is used in addition for thermal activation. When converting the individual gases in the fuel cell stack, a large amount of heat is generated as a by-product. This generated heat heats the anode exhaust gas and the cathode exhaust gas accordingly. The heat present in the cathode exhaust gas can now be used, at least in part, for the thermal activation of such a cooling device. A thermally activated cooling device thus means that hot cathode exhaust gas is used as energy within this thermally activated cooling device, thereby being cooled, and thus provides a heat sink. In order to use this thermal energy for cooling, an absorption heat pump is usually provided in a thermally activated cooling device, so that it is possible to create a heat sink for the anode exhaust gas as anode recirculation gas through absorption processes and desorption processes. Here again, it can clearly be seen how such an active cooling device does not require any external energy or any external cooling circuit. Apart from a possibly necessary circulation pump for the coolant between the absorption section and the desorption section of such a thermally activated cooling device, no external energy inflow and in particular no supply of an external cooled coolant is necessary.

Alternatively or additionally, it is conceivable that, in a fuel cell system according to the invention, the active cooling device comprises an electrically activated cooling device. This can be provided in addition to or as an alternative to a thermally activated cooling device. In particular, this can be a refrigeration circuit machine that uses a compressor to form a classic heat pump. In this way, it is possible to provide the desired heat sink by introducing electrical energy directly at the location of the active cooling device and accordingly provide the condensation function for the condensation water in the anode recirculation gas.

Further advantages can be achieved if, in a fuel cell system according to the invention, the anode recirculation section has a condenser device in heat-transferring contact with a cathode feed section. This is used to cool the anode recirculation gas by heating up the cathode feed gas. In this case, a further water outlet is located downstream of the condenser device and upstream of the active cooling device to discharge the condensation water condensed in the condenser device. In other words, in this embodiment two-stage cooling and thus also two-stage condensation is now possible. This means that the anode exhaust gas leaves the anode section with a high outlet temperature and is brought in several steps to the desired temperature at which it is added to the fuel gas as anode recirculation gas. This involves two steps of cooling and also two steps of condensation, so that in a first step the still-hot anode exhaust gas is cooled via the ambient air, whereby the ambient air can have different ambient air temperatures in different regions. This means that, in particular in hot regions, the ambient air sucked in as cathode feed gas can also have a temperature of 50° Celsius and more, which limits the cooling effect on the hot anode exhaust gas. Since the volume flow of air as cathode feed gas can only to a limited extent be flexibly varied, this cooling and condensation can be arranged downstream of an active cooling device according to the invention, which, however, can be made smaller and more compact compared to the general solution, since pre-condensation has already been provided by the condenser device. Due to the corresponding separators in the water outlets, the cooling water discharged at the two water outlets can be discharged into the environment separately or can be combined and discharged together.

In addition, it can be advantageous if the cathode discharge section of a fuel cell system according to the invention is designed without a catalyst device and/or a burner. As has already been explained, a fuel cell system according to the invention serves in particular to provide a complete recirculation of the anode exhaust gas as anode recirculation gas. This means that anode exhaust gas is no longer discharged into the environment and therefore no post-treatment of any residual fuel present in this anode exhaust gas is necessary. Instead, only the cathode exhaust gas is released into the environment, which, however, is free of fuel in a functioning fuel cell. The omission of a catalyst device and/or burner leads to a smaller, lighter and cheaper design of the fuel cell system as a whole.

In addition, it can bring advantages if, in a fuel cell system according to the invention, the anode discharge section and the anode recirculation section are designed without a divider section to enable a complete or substantially complete recirculation of the anode exhaust gas as anode recirculation gas. As has already been explained, this is only made possible in that an active cooling device is used, and brings other advantages, for example the possibility of dispensing with a catalyst device as described in the previous paragraph. This means that there are no exhaust gases to be discharged into the environment on the anode side and thus no need for post-treatment. By dispensing with such a divider section, it is now also possible to design the entire system of the fuel cell system without such a component, thus allowing a simpler, more cost-effective and smaller design.

It also brings advantages if, in a fuel cell system according to the invention, a discharge valve is arranged in the anode recirculation section downstream of the active cooling device and downstream of the water outlet to enable a controlled discharge of at least part of the recirculation gas. Due to the fact that a complete recirculation rate for the anode exhaust gas is preferably provided for a fuel cell system according to the invention, it may happen that in special situations this complete recirculation is undesirable for the fuel cell system. In order to provide flexibility of control, a discharge valve can be used here to discharge part of the recirculation gas into the environment using at least a qualitative, preferably a quantitative control method. Since the anode recirculation gas usually still contains residual amounts of fuel, a catalyst device can preferably be integrated into such a discharge valve to enable catalytic post-treatment of the anode exhaust gas as anode recirculation gas for such a special case and in this way oxidise the residual fuel. In particular, the discharge valve is provided and designed exclusively for a controlled discharge of at least part of the recirculation gas. In particular, this does not result in any form of heat transfer, nor does it create a permanent division. If the hydrogen is at least almost pure, such a discharge valve is usually not provided.

It can be advantageous if, in a fuel cell system according to the invention, the anode discharge section has an anode discharge heat exchanger in heat-transferring contact with the anode feed section to transfer heat from the anode exhaust gas to the anode feed gas. This makes possible a further increase in efficiency from the point of view of temperature. In connection with the other possible different heat exchangers explained later, a heat exchanger system is created together with the active cooling device which can also be referred to as a temperature control system, which allows the greatest possible proportion of residual heat in the anode exhaust gas as well as in the cathode exhaust gas to be recycled and used for other functions, for example condensation, but also the feed and conditioning of anode feed gas and cathode feed gas. In this embodiment, there is thus a possibility of cooling the hot anode exhaust gas and using this energy to heat up the anode feed gas as it is fed to the anode section. As a side effect, this leads to anode exhaust gas which has already been pre-cooled arriving at the active cooling device, so that lower input temperatures can accordingly be assumed at the active cooling device, and the necessary cooling capacity is thus less.

It can also bring advantages if, in a fuel cell system according to the invention, the mixing section is designed as an ejector device, with a fuel feed of fuel gas at a primary connection of the ejector device and the anode recirculation section at the secondary connection of the ejector device. The use of an ejector device as an alternative to classic blower devices for the mixing section brings many advantages.

On the one hand, rotating components and corresponding parts subject to wear are dispensed with. On the other hand, mixing and conveying are preferably combined in a common component, so that, particularly if a fuel gas source with high delivery pressure is available, a separate conveying device in the anode feed section is no longer necessary. Rather, it is sufficient to apply the corresponding fuel gas to the primary connection of the ejector device with the desired input pressure, so that the corresponding suction effect resulting at the secondary connection of the ejector device sucks in the dried anode recirculation gas for mixing. The overall efficiency is thus further increased for a fuel cell system according to the invention and, in particular, the low-wear properties are improved.

Another advantage is achievable if, in a fuel cell system according to the invention, the cathode feed section has a cathode feed heat exchanger in heat-transferring contact with the cathode discharge section to transfer heat from the cathode exhaust gas to the cathode feed gas. Similarly to the preheating of the anode feed gas, it further increases the efficiency in the operation of the fuel cell system if the cathode feed gas is also preconditioned so that it enters the cathode section at the highest possible temperature, and thus in particular close to the operating temperature of the fuel cell stack. Since the cathode exhaust gas has been brought to a correspondingly high outlet temperature as a result of the chemical reaction within the fuel cell stack, this high temperature can be used here to be partially transferred to the cathode feed gas. This corresponds to a preconditioning in the form of preheating from the cathode exhaust gas to the cathode feed gas. This recovery of the heat contained in the cathode exhaust gas increases efficiency even further and avoids heat loss through the cathode exhaust gas.

It also brings advantages if, in a fuel cell system according to the invention, a cathode discharge heat exchanger is arranged in the anode feed section, preferably downstream of an anode feed heat exchanger, to transfer heat from the cathode exhaust gas to the anode feed gas. This allows heat also contained in the cathode exhaust gas to be transferred to the anode feed gas, in addition or alternatively. In addition, in combination with an anode feed heat exchanger, this also makes it possible to increase the corresponding preheating functionality even further, or in other words to bring the anode feed gas to an even higher temperature. As shown, the system of heat exchangers in a fuel cell system according to the invention can be provided at a variety of positions via heat exchanger functions. Of course, individual heat exchangers of this heat exchanger system can be controlled via valves, so that different parts of this heat exchanger system can be activated or deactivated, in particular flexibly, depending on the operating situation. This makes it possible to react specifically and flexibly to different operating situations and always achieve maximum temperature efficiency.

It can also be advantageous if, in a fuel cell system according to the invention, a cathode feed heat exchanger is arranged in the cathode feed section to transfer heat from the cathode exhaust gas to the cathode feed gas. This is also conceivable as an alternative, but also in addition to the other heat exchangers mentioned, whereby it should be pointed out that valves can preferably activate and deactivate the different heat exchangers. Here too, it is again possible, through the transfer of heat, to use residual heat from the cathode exhaust gas in order to be able to guarantee preconditioning in the form of pre-heating of the cathode feed gas and thus further increase the operating efficiency of the fuel cell system.

In addition, it can be advantageous if, in a fuel cell system according to the invention, a control valve is arranged in the anode feed section upstream of the mixing section to control the volume flow of fuel gas through the mixing section. This makes it possible to control the quantity and pressure of the fuel gas, in particular from a pressurised fuel gas source, in a controlled manner. Depending on the amount of anode recirculation gas diverted, a correspondingly adapted amount of fuel gas can now be added, so that the desired composition and the desired volume flow of anode feed gas is always actually made available to the anode section. It is therefore preferable that this control valve is a quantitatively controllable control valve in order to be able to react flexibly to a wide variety of operating situations of the fuel cell system.

In addition, it is advantageous if, in a fuel cell system according to the invention, the anode discharge section is designed without an external cooling circuit. As has already been explained, the core idea of the present invention is to provide this condensation function as efficiently as possible and without additional complexity. The design of the anode discharge section without an external cooling circuit embodies precisely this reduced complexity, since the condensation function is at least partially guaranteed exclusively by the heat sink of the active cooling device.

It is also advantageous if, in a fuel cell system according to the invention, a cathode mixing section, in particular in the form of an ejector device, is arranged in the cathode feed section. A cathode recirculation section is connected to this ejector device in a fluid-communicating manner at the secondary connection to provide a recirculation of part of the cathode exhaust gas as cathode recirculation gas. In combination with the recirculation to the anode section, this can also be referred to as double recirculation. This makes it possible to feed the cathode exhaust gas and the residual oxygen contained therein back into the cathode section as an admixture with the cathode feed gas.

In principle, it can also be advantageous in the context of the invention if regenerative adsorption is provided. In this process, water contained in the water vapour is regeneratively separated, for which purpose silicone gel pads for example can be provided. In particular, regenerative separation elements such as silicone gel pads are arranged in the active cooling device.

The subject matter of the present invention also includes a method for a recirculation of anode exhaust gas as anode recirculation gas in a fuel cell system according to the invention, comprising the following steps:
cooling the anode recirculation gas to below the boiling temperature of water by active cooling by means of the active cooling device,
separating the condensed condensation water from the anode recirculation gas,
mixing the dried recirculation gas with a fuel gas to form anode feed gas.

The use of a method according to the invention in a fuel cell system according to the invention brings the same advantages as have been explained in detail with reference to a fuel cell system according to the invention.

Further advantages, features and details of the invention are explained in the following description, in which embodiments of the invention are described in detail with reference to the drawings. In each case schematically:

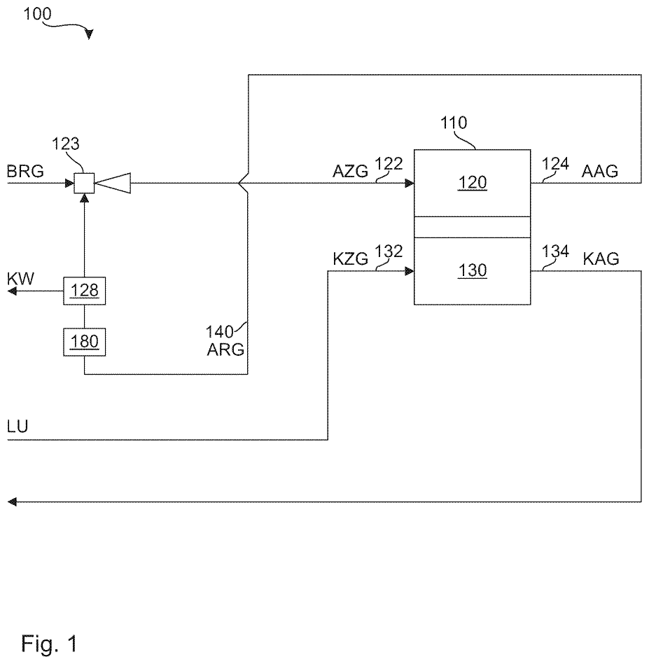

FIG. 1 shows an embodiment of a fuel cell system according to the invention,

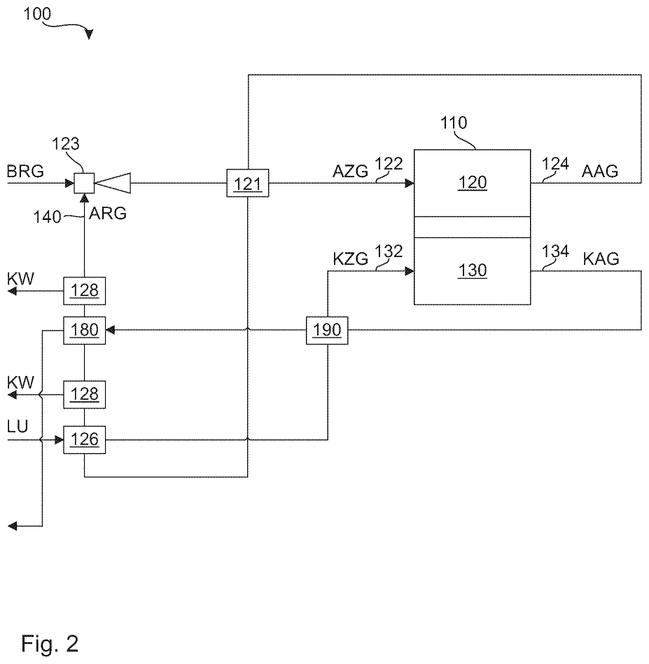

FIG. 2 shows a further embodiment of a fuel cell system according to the invention,

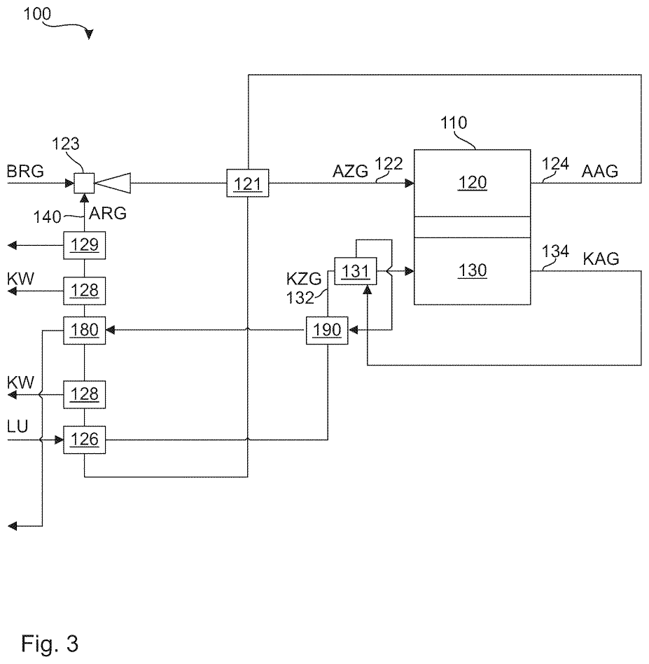

FIG. 3 shows a further embodiment of a fuel cell system according to the invention,

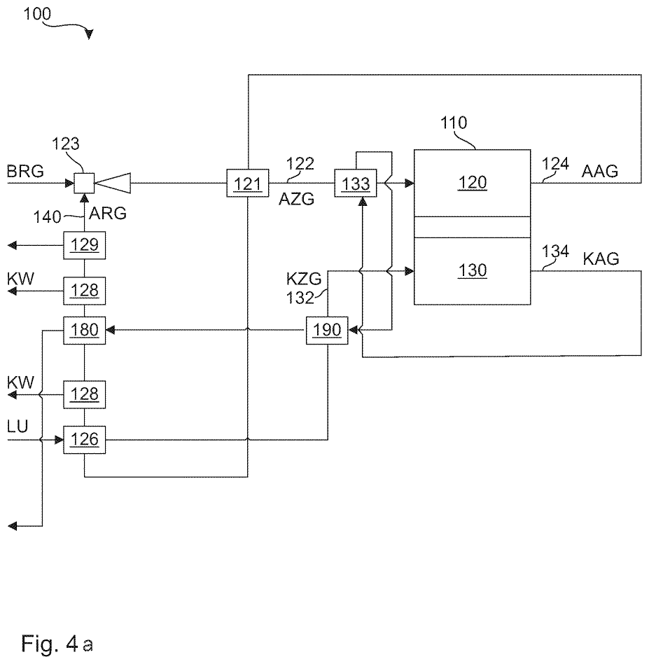

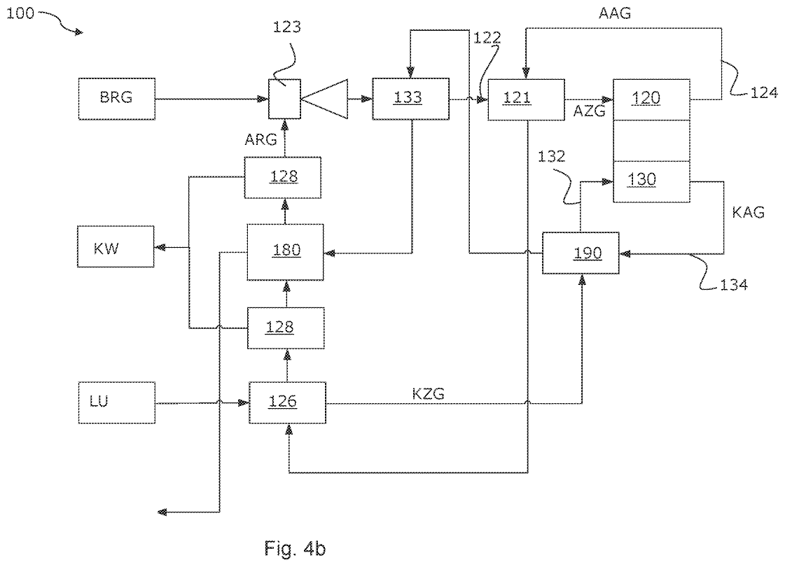

FIG. 4a shows a further embodiment of a fuel cell system according to the invention,

FIG. 4b shows a further embodiment of a fuel cell system according to the invention,

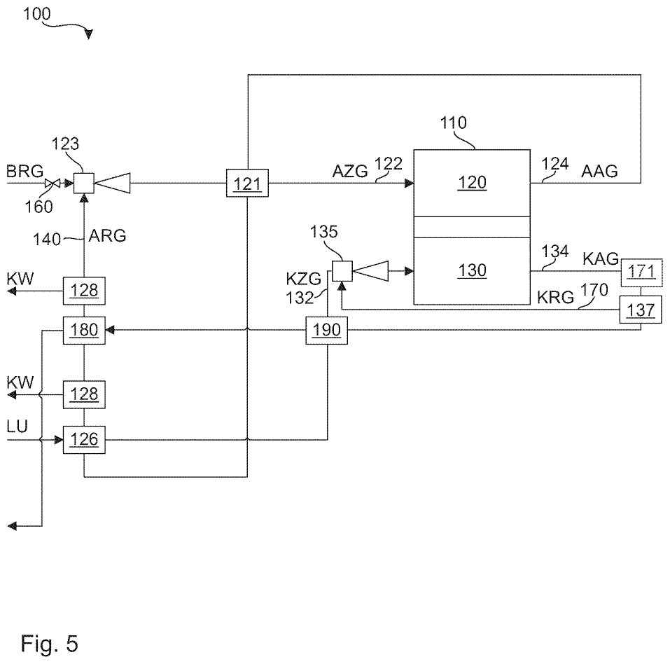

FIG. 5 shows a further embodiment of a fuel cell system according to the invention,

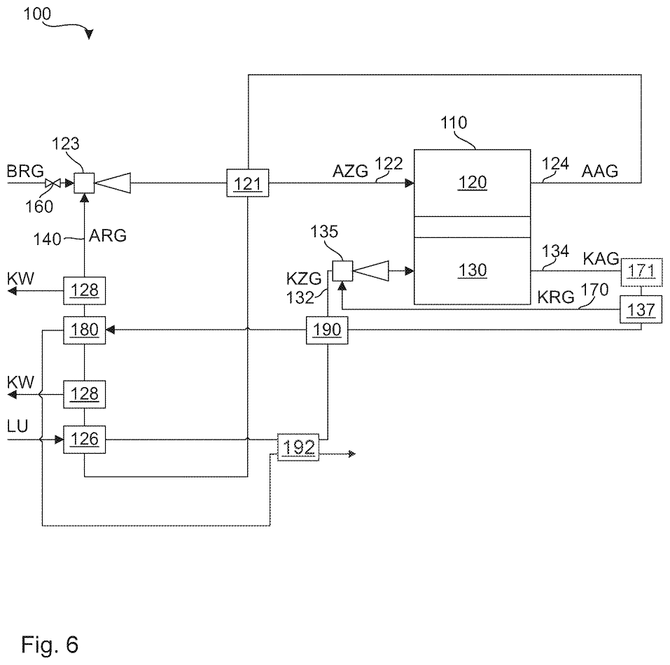

FIG. 6 shows a further embodiment of a fuel cell system according to the invention.

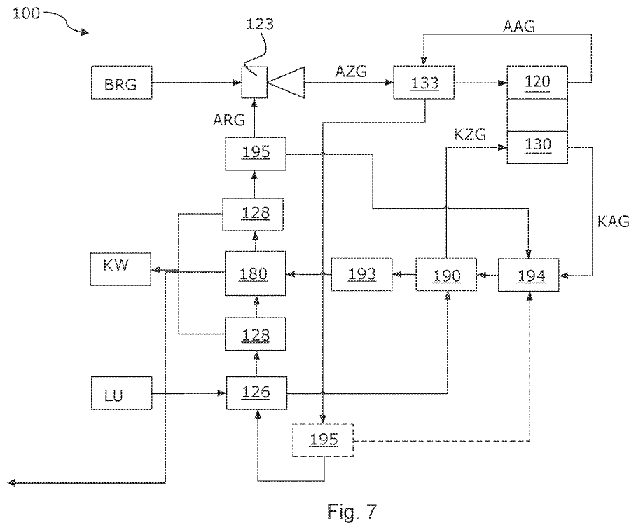

FIG. 7 shows a further embodiment of a fuel cell system according to the invention.

FIG. 1 shows schematically a fuel cell system 100 which has a fuel cell stack 110 with an anode section 120 [and] a cathode section 130. The anode section is supplied with anode feed gas AZG via an anode feed section 122 and the anode exhaust gas AAG is discharged via the anode discharge section 124. In the same way, the cathode section 130 is supplied with cathode feed gas KZG, here in the form of air LU, via a cathode feed section 132, and the cathode exhaust gas KAG is discharged via the cathode discharge section 134. As can be clearly seen in FIG. 1, the anode section is a so-called dead-end design, since 100%, i.e. all of the anode exhaust gas AAG is also recirculated as anode recirculation gas ARG. In terms of construction design, this is achieved in that the anode discharge section 124 transitions into the anode recirculation section 140. In order to provide the desired drying for this recirculation of the anode exhaust gas AAG, an active cooling device 180 is arranged in the further course of the anode recirculation section 140 which actively provides a heat sink for cooling the anode recirculation gas ARG at this point, and thus without any external cooling connections. The cooling function is designed as a condensation function, so that the anode recirculation gas ARG is cooled below the boiling temperature of water, which depends on the partial pressure, e.g., for the sake of simplicity, 100 degrees Celsius. The cooled anode circulation gas ARG is thus condensed with regard to the water content and the now liquefied condensation water KW is discharged via a separator into the water outlet 128 from the anode recirculation section 140. The dried anode recirculation gas ARG is fed here into an injector device as mixing section 123, where it is mixed with fuel gas BRG, whereby this mixed gas is then fed back into the anode section 120 as anode feed gas AZG. It is easy to see here that the one hundred percent recirculation rate allows maximum efficiency to be achieved in the use of the fuel gas BRG, also from the anode exhaust gas AAG. The reduction in the Nernst voltage due to the water content of the anode recirculation gas ARG which would otherwise have to be accepted can be avoided or at least reduced here, since the water contained can be at least partially condensed out and discharged via the water outlet 128 cost-effectively and easily with the help of an active cooling device 180.

FIG. 2 shows a further development of the embodiment of FIG. 1. Here, upstream heat transfer systems are provided to supplement the active cooling device 180 and thus further increase the efficiency of the overall system. The individual components of this additional temperature control system can of course be freely combined with each other, where technically expedient.

Thus, FIG. 2 shows an anode feed heat exchanger 121 which is able to ensure a heat exchange from the hot anode exhaust gas AAG to the anode feed gas AZG which is to be heated. This allows the anode feed gas AZG to be conditioned and pre-heated in order to have a desired higher inlet temperature into the anode section 120. At the same time, the anode exhaust gas AAG is pre-cooled here, so that the necessary cooling capacity, in particular at the active cooling device 180, is further reduced in this way. The dimensioning of the active cooling device 180 can accordingly be smaller. In addition, in order to provide further pre-cooling, in particular to already provide partial condensation, a condenser device 126 is integrated into the cathode feed section 132. A heat exchange takes place there between the anode exhaust gas AAG and the air LU supplied as cathode feed gas KZG. The air is thus sucked in from the environment and warmed up here through the transfer of heat from the hot anode exhaust gas AAG. In the same way, in particular in combination with the anode feed heat exchanger 121 already explained, a first condensation step is already created here, the anode exhaust gas AAG, in this case as anode recirculation gas ARG, is thus cooled to a temperature of less than 100° Celsius. This means that at least part of the water from the anode recirculation gas ARG condenses out here and is discharged as condensation water KW via a separate water outlet 128. The active cooling device 180, which makes possible even further cooling and thus an even more effective drying of the anode recirculation gas, is arranged downstream. The effect according to the invention is further enhanced in this case by the three-stage cooling of the anode exhaust gas as anode recirculation gas ARG.

FIG. 2 also shows an additional detail variant of the activity of the active cooling device 180. In this case, this is designed as a thermally activated cooling device 180. The thermal activation is provided by the fuel cell system itself, since hot cathode exhaust gas KAG is also directed from the cathode discharge section 134 to the activation area of the active cooling device 180. As already indicated, such a thermally activated cooling device 180 can for example be designed as an absorption heat pump, whereby the necessary heat activation is provided by the increased temperature of the cathode exhaust gas KAG. Since the cathode exhaust gas KAG also usually has a very high temperature and the cathode feed gas KZG can also be preconditioned to an elevated temperature, in the embodiment of FIG. 2 an air-heat exchanger 190 is also provided in the overall temperature control system of the fuel cell system 100. This allows the very hot cathode exhaust gas KAG to be used, in a first step, for the preconditioning of the cathode feed gas KZG and then allows the remaining residual heat to be used for the thermal activation of the active cooling device. In the opposite direction, for the supplied air LU as cathode feed gas KZG, this means that two heating stages are provided here, namely through the compensator device 126 and the aforementioned air-heat exchanger 190.

FIG. 3 also shows a further development of the embodiment of FIGS. 1 and 2. Here too, further additional components have been added which can be used individually or in combination with the other components of the temperature control system. One of these components is a cathode feed heat exchanger 131, which is used here as a third heating stage for heating up the cathode feed gas 132. In addition, a discharge valve 129 is also provided here which provides additional flexibility due to the one hundred percent recirculation rate of the anode exhaust gas.

In special situations in which the amount of anode recirculation gas ARG is greater than required, such a discharge valve 129, also referred to as a blowout valve, can provide a discharge function for part or all of the anode recirculation gas ARG.

FIG. 4a also shows further components of a temperature control system, in particular with regard to additional temperature control of the anode feed gas AZG by means of the heated cathode exhaust gas KAG. For this purpose, a cathode discharge heat exchanger 133 is arranged in the anode feed section 122 to ensure the aforementioned heat transfer.

FIG. 4b shows a fuel cell system 100 which largely corresponds to that of FIG. 4a. However, in FIG. 4b, the one cathode discharge heat exchanger 133 is arranged with the cold side downstream of the anode feed heat exchanger 121. The hot anode exhaust gas AAG is thus passed through a warm side of the anode feed heat exchanger 121, which brings the anode feed gas AZG further up to operating temperature. Here, the cathode exhaust gas KAG is passed through the warm side of the cathode discharge heat exchanger 133, whereby the anode feed gas AZG is first heated by the cathode exhaust gas KAG in the cathode discharge heat exchanger 133 and then by the anode discharge gas AAG in the anode feed heat exchanger 121. In contrast, in the design according to FIG. 4a, the anode feed gas AZG is first heated by the anode discharge gas AAG in the anode feed heat exchanger 121 and then by the cathode exhaust gas KAG in the cathode discharge heat exchanger 133.

FIG. 5 also shows further components with which the fuel cell system 100 can be further developed. On the one hand, these are a cathode recirculation fan 171 and a cathode divider section 137 which allow a part of the cathode exhaust gas KAG to be diverted into a cathode recirculation section 170. This means that this diverted part of the cathode exhaust gas KAG can be fed as cathode recirculation gas KRG into an ejector device as cathode mixing section 135 and cathode recirculation can be guaranteed. Thus, a variable recirculation fraction at the cathode is possible, whereby higher recirculation rates can be set under partial load operation. The remaining cathode exhaust gas KAG is fed to the catalyst device 136 in the way already explained several times.

Also shown in FIG. 5 is a control valve 160 in the fuel gas feed for the fuel gas BRG. This is in particular designed to be quantitatively controllable, so that different volume flows of fuel gas BRG can be set and different quantities of fuel gas can also actually be added to the anode recirculation gas ARG for different operating situations.

FIG. 6 shows another component with which the fuel cell system 100 can be further developed. Thus, in the embodiment shown in FIG. 6, a further air-heat exchanger 192 is additionally provided in the overall temperature control system of the fuel cell system 100 which, in a further step for the preconditioning of the cathode feed gas KZG, allows residual heat from the cathode exhaust gas KAG to be used before it is discharged into the environment. In the opposite direction, for the supplied air LU as cathode feed gas KZG, this means that three heating stages are provided here, namely through the condenser device 126, the air heat exchanger 192 and the air heat exchanger 190.

FIG. 7 shows another fuel cell system 100. Those elements which have the same reference sign as in the previous embodiments correspond to these and are not described further. A discharge valve 195 is provided here, via which anode exhaust gas AAG can be discharged from the anode recirculation section 140. The dashed representation of the discharge valve 195 shows a further possible arrangement of the same. The discharge valve 195 may be necessary when a fuel such as hydrogen or ammonia contains impurities such as nitrogen or carbon dioxide in order to prevent an accumulation of the inert and non-condensable gases in the anode path. The discharge valve 195 can be opened periodically or a continuous discharge can also take place. In order to chemically convert anode exhaust gas, an exhaust gas conversion device 194 is provided which is for example designed as an oxidation catalyst. In addition, a post-treatment unit 193 is provided here which is arranged downstream of the air-heat exchanger 190. The post-treatment unit 193 is particularly advantageous when operating the fuel cell system 100 with ammonia, in order to convert traces of ammonia once again before the exhaust gas is released into the environment. For this purpose, the post-treatment unit 193 can for example be designed as an ammonia slip catalyst (ASC) which functions at temperatures between 200° C. and 500° C.

The individual components, in particular the system consisting of a large number of heat exchangers, can be freely combined with each other and, in particular, can be freely switched via control valve systems in order to be able to react as flexibly as possible to a wide variety of operating situations of the fuel cell system 100.

In this context, further alternative features and combinations of features are explicitly suggested below.

For example, the component of the ejector device as cathode mixing section 135 from the embodiment of the fuel cell system 100 shown in FIG. 5 can also be combined with the embodiments of the fuel cell system 100 from FIG. 6 which include the component of the further air-heat exchanger 192.

Furthermore, in an embodiment which includes the aforementioned components of the ejector device as cathode mixing section 135 from FIG. 5 and the further air-heat exchanger 192 from FIG. 6, the cooling device 180 can be supported by a water cooling system which may be usable in a system environment involving use of the fuel cell system 100.

In addition, in an embodiment which includes the aforementioned component of the further air-heat exchanger 192 from FIG. 6, a blower may be used as cathode mixing section 135 instead of the ejector device shown in FIG. 5.

Alternatively, in an embodiment comprising said component of the further air-heat exchanger 192 from FIG. 6, and in which said blower is used as cathode mixing section 135 instead of the ejector device from FIG. 5, the cooling device 180 can be supported by said water cooling system which may be usable in a system environment involving use of the fuel cell system 100.

The above explanation of the embodiments describes the present invention exclusively in the context of examples.

### LIST OF REFERENCE SIGNS

100 fuel cell system
110 fuel cell stack
120 anode section
121 anode feed heat exchanger
122 anode feed section
123 mixing section
124 anode discharge section
126 condenser device
128 water outlet
129 discharge valve
130 cathode section
131 cathode feed heat exchanger
132 cathode feed section
133 cathode discharge heat exchanger
134 cathode discharge section
135 cathode mixing section
140 anode recirculation section
160 control valve
170 cathode recirculation section
171 cathode recirculation fan
180 active cooling device
192 air-heat exchanger
193 post-treatment unit
194 exhaust gas conversion device
195 discharge valve
AZG anode feed gas
AAG anode exhaust gas
ARG anode recirculation gas
KZG cathode feed gas
KAG cathode exhaust gas
KRG cathode recirculation gas
BRG fuel gas
LU air
KW condensation water

1. Fuel cell system for generating electrical energy, comprising a fuel cell stack with an anode section and a cathode section the anode section comprising an anode feed section for supplying anode feed gas (AZG) and an anode discharge section for discharging anode exhaust gas (AAG), wherein the anode discharge section transitions into an anode recirculation section for recirculating the anode exhaust gas (AAG) as anode recirculation gas (ARG) to the anode feed section, the cathode section comprising a cathode feed section for supplying cathode feed gas (KZG) and a cathode discharge section for discharging cathode exhaust gas, wherein an active cooling device is arranged in the anode recirculation section for cooling the anode recirculation gas (ARG), wherein a water outlet is arranged downstream of the active cooling device to discharge the condensation water (KW) condensed in the active cooling device, wherein a mixing section is arranged downstream of the water outlet for mixing the anode recirculation gas (ARG) with fuel gas (BRG) and for supplying this, as anode feed gas (AZG), into the anode feed section, characterised in that the active cooling device comprises a thermally activated cooling device, in particular comprising an absorption heat pump, wherein the active cooling device is arranged in heat-transferring contact with the cathode discharge section for thermal activation by means of the heat contained in the cathode exhaust gas (KAG).

2. (canceled)

3. Fuel cell system according to claim 1, wherein the active cooling device comprises an electrically activated cooling device.

4. Fuel cell system according to claim 1, wherein the anode recirculation section has a condenser device in heat-transferring contact with the cathode feed section for cooling the anode recirculation gas (ARG) by heating the cathode feed gas (KZG), wherein a water outlet is arranged downstream of the condenser device and upstream of the active cooling device to discharge the condensation water (KW) condensed in the condenser device.

5. Fuel cell system according to claim 1, wherein the cathode discharge section is designed without a catalyst device and/or a burner.

6. Fuel cell system according to claim 1, wherein the anode discharge section and the anode recirculation section are designed without a divider section to enable a complete or substantially complete recirculation of the anode exhaust gas (AAG) as anode recirculation gas (RZG).

7. Fuel cell system according to claim 1, wherein a discharge valve is arranged in the anode recirculation section downstream of the active cooling device and downstream of the water outlet to enable a controlled discharge of at least part of the recirculation gas (RZG).

8. Fuel cell system according to claim 1, wherein the anode discharge section has an anode feed heat exchanger in heat-transferring contact with the anode feed section to transfer heat from the anode exhaust gas (AAG) to the anode feed gas (AZG).

9. Fuel cell system according to claim 1, wherein the mixing section is designed as an ejector device, with a fuel feed of fuel gas (BRG) at a primary connection of the ejector device and the anode recirculation section at the secondary connection of the ejector device.

10. Fuel cell system according to claim 1, wherein the cathode feed section has a cathode feed heat exchanger in heat-transferring contact with the cathode discharge section to transfer heat from the cathode exhaust gas (KAG) to the cathode feed gas (KZG).

11. Fuel cell system according to claim 1, wherein a cathode discharge heat exchanger is arranged in the anode feed section, preferably downstream of an anode feed heat exchanger, to transfer heat from the cathode exhaust gas (KAG) to the anode feed gas (AZG).

12. Fuel cell system according to claim 1, wherein a control valve is located in the anode feed section upstream of the mixing section to control the volume flow of fuel gas (BRG) through the mixing section.

13. Fuel cell system according to claim 1, wherein the anode discharge section is designed without an external cooling circuit.

14. Fuel cell system according to claim 1, wherein a cathode mixing section, in particular in the form of an ejector device, is arranged in the cathode feed section, a cathode recirculation section being connected in a fluid-communicating manner to the secondary connection thereof to recirculate part of the cathode exhaust gas (KZG) as cathode recirculation gas (KRG).

15. Method for recirculating anode exhaust gas (AZG) in a fuel cell system having the features of claim 1 as anode recirculation gas (ARG), comprising the following steps:
cooling the anode recirculation gas (ARG) to below the boiling temperature of water by active cooling by means of the active cooling device,
separating the condensed condensation water (KW) from the anode recirculation gas (ARG),
mixing the dried anode recirculation gas (ARG) with a fuel gas (BRG) to form anode feed gas (AZG).
